(19) United States
(12) Patent Application Publication
(10) Pub. No.: US 2008/0094730 A1
(43) Pub. Date: Apr. 24, 2008

(54) Optical device and imaging apparatus

(75) Inventor: Yusuke Toma, Saitama (JP)

Correspondence Address: FOLEY AND LARDNER LLP;SUITE 500, 3000 K STREET NW, WASHINGTON, DC, 20007, US

(73) Assignee: TAMRON CO., LTD.

(21) Appl. No.: 11/892,860

(22) Filed: Aug. 28, 2007

(30) Foreign Application Priority Data
Oct. 20, 2006 (JP) 2006-286449

(51) Int. Cl. G02B 7/04

(52) U.S. Cl. 359/703

(57) ABSTRACT

A lens apparatus includes a plurality of lenses movable in a direction of the optical axis, a guide pole that extends in the direction of the optical axis and that is moved integrally with arbitrary lenses among the lenses, and a slide unit that is slidable along the guide pole and that is moved integrally with others lenses among the lenses. This makes an optical axis of the other lens moving along the guide pole to be aligned with an optical axis of the lens apparatus, by adjusting a position of the arbitrary lenses so that an optical axis of the arbitrary lenses is aligned with the optical axis of the lens apparatus.

### BACKGROUND OF THE INVENTION

1. Field of the Invention

The present invention relates to an optical device and an imaging apparatus.

2. Description of the Related Art

Conventionally, optical devices are provided each including a plurality of lenses movable in a direction of an optical axis in such a manner that the lenses are moved in the direction of the optical axis to adjust a focal position. In such an optical device, the movable lenses are held by separate lens barrels for convenience of manufacturing, respectively, such that a first barrel holding one lens movable in the direction of the optical axis is coupled to a second barrel holding another lens movable in the direction of the optical axis, in manufacturing the optical device.

Further, there has conventionally been an optical device that has a guide pole that guides positions of the lenses to prevent deviation of optical axes of a plurality of lenses from a proper optical axis. Such a guide pole is provided in each barrel holding an associated movable lens, or provided in any one of barrels holding associated movable lenses, respectively.

Specifically, such a technique is provided that includes a rod-like member extending in a direction of an direction of the optical axis and provided within an applicable barrel, and a lens holding frame that holds an associated lens and is formed with a through hole penetrating the lens holding frame in the direction of the optical axis. The lens is moved in a state where the rod-like member is inserted through the hole, so that deviation of the lens from a proper optical axis while moving the lens is prevented. Such a technique is disclosed in, for example, Japanese Patent Application Laid-Open No. H8-240758.

Furthermore, there is an imaging apparatus configured to accommodate lens barrels within a body of the imaging apparatus in a non-imaging state, to readily and highly precisely adjust a position of each lens barrel upon retracting the lens barrel into a position different from a position on an optical axis of the lens barrel. Such a technique is disclosed, for example, Japanese Patent Application Laid-Open No. 2004-233919.

However, the above conventional optical devices held the lenses in separate barrels, thereby causing such a problem that an assembling error between barrels leads to a deviation between optical axes of lenses to deteriorate optical performance. Similarly, in the optical device in which the guide pole is provided in each of the barrels holding a movable lens, an assembling error between barrels leads to deviation between optical axes of lenses to deteriorate optical performance.

Furthermore, in the optical device in which a guide pole is provided in one of the barrels holding a movable lens, it is certainly possible to set the reference in moving the lenses with the guide pole, however, assembling errors among the barrels disable assurance of optical performance of the lenses held by the other barrels provided with no guide poles, to deteriorate the optical performance.

### SUMMARY OF THE INVENTION

It is an object of the present invention to at least solve the above problems in the conventional technologies.

An optical device according to one aspect of the present invention has a plurality of lenses that are movable in a direction of an optical axis. The optical device includes a guide member that extends in the direction of the optical axis and that is integrally moved with one of the lenses; and a slide unit that is slidable along the guide member, and that is integrally moved with another one of the lenses.

An imaging apparatus according to another aspect of the present invention includes the optical device according to claim 1, and an imaging mechanism including a photoelectric conversion element that converts incident light entering through the optical device, into an electrical signal.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-section of a zoom lens apparatus according to a first embodiment of the present invention;

FIG. 2 is a cross-section of a zoom lens apparatus according to a second embodiment of the present invention;

FIG. 3 is a cross-section of a zoom lens apparatus according to a third embodiment of the present invention;

FIG. 4 is a cross-section of a zoom lens apparatus according to a fourth embodiment of the present invention;

FIG. 5 is a cross-section of a zoom lens apparatus according to a fifth embodiment of the present invention;

FIG. 6 is a cross-section of a zoom lens apparatus according to a sixth embodiment of the present invention; and

FIG. 7 is an enlarged view of a lens supporting member in FIG. 6.

### DETAILED DESCRIPTION OF THE PREFERRED EMBODIMENTS

Exemplary embodiments according to the present invention will be explained in detail below with reference to the accompanying drawings. The embodiments are examples applied to a zoom lens apparatus that realizes an optical device according to the present invention.

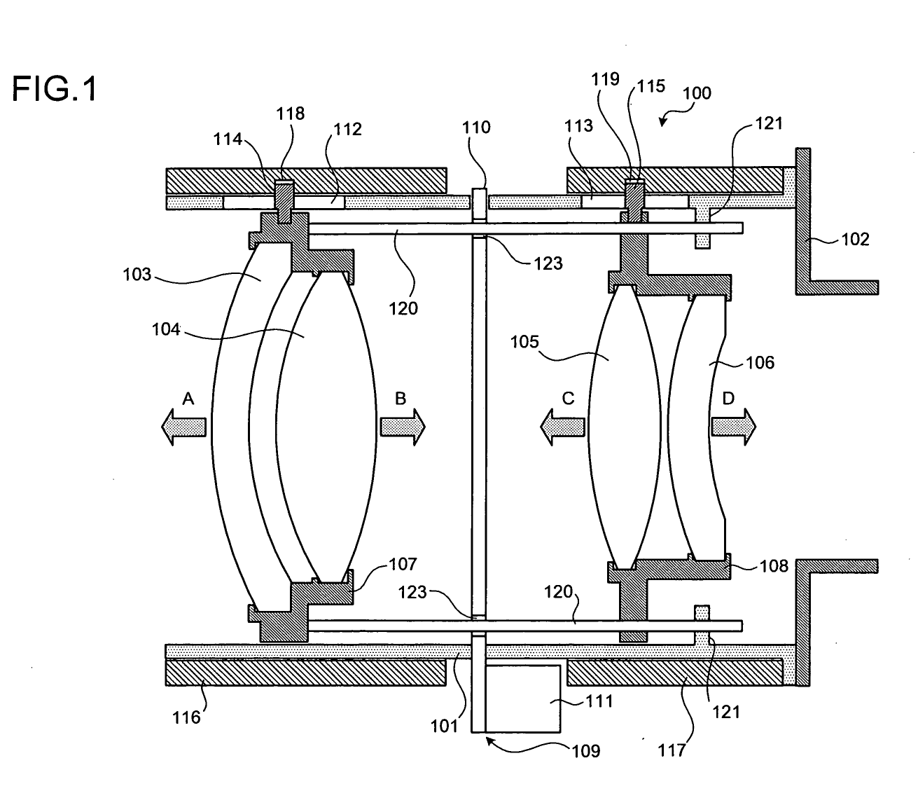

FIG. 1 is a cross-section of a zoom lens apparatus according to a first embodiment of the present invention. As shown in FIG. 1, a zoom lens apparatus 100 according to the first embodiment includes a substantially cylindrical lens barrel 101 having a center axis along a direction of an optical axis of the zoom lens apparatus 100. The lens barrel 101 is supported by a mount 102 provided at one side of the lens barrel 101 in the direction of the optical axis.

The zoom lens apparatus 100 is used as an imaging apparatus by coupling it to a surveillance camera, for example. Although omitted in the figure, the surveillance camera has an imaging mechanism that includes a photoelectric conversion element for imaging such as a charge coupled device (CCD) that converts incoming outside light into an electrical signal. The zoom lens apparatus 100 is mounted on a housing accommodating the imaging mechanism therein, through a bayonet mechanism or helicoid mechanism provided between the zoom lens apparatus and the housing. In this case, the mount 102 is realized by a part of the housing.

Provided inside the lens barrel 101 is a plurality of lenses 103 to 106 disposed on a set of optical axes. Among the lenses 103 to 106, the lens designated by reference numeral 103 in FIG. 1 (hereinafter, “L1 lens”) and the lens designated by reference numeral 104 in FIG. 1 (hereinafter, “L2 lens”) are held by an L1/L2 lens frame 107. Further, among the lenses 103 to 106, the lens designated by reference numeral 105 in FIG. 1 (hereinafter, “L3 lens”) and the lens designated by reference numeral 106 in FIG. 1 (hereinafter, “L4 lens”) are held by an L3/L4 lens frame 108.

The lens barrel 101 includes a diaphragm unit 109 that adjusts an amount of light incident on the L3 lens 105 after passing through the L1 lens 103 and L2 lens 104. Although explanation is omitted, the diaphragm unit 109 includes a diaphragm blade mechanism 110 that variably adjusts a diameter of an aperture that allows light incident on the L3 lens 105 to pass therethrough, and a driving unit 111 that drives diaphragm blades to vary the diameter of the aperture. For example, iris-diaphragm blades can be used as the diaphragm blade mechanism 110.

The lens barrel 101 is formed with long holes 112 and 113 having longitudinal directions aligned with the direction of the optical axis. In the long holes 112 and 113, operation transmitting members 114 and 115 are inserted. The operational transmitting members 114 and 115 are slidable in the direction of the optical axis within the long holes 112 and 113, respectively. The operation transmitting member 114 is mounted on the L1/L2 lens frame 107. This provides the L1/L2 lens frame 107 to be movable in the direction of the optical axis within the lens barrel 101.

At an outer periphery side of the lens barrel 101, an L1/L2 lens frame operating ring 116 and an L3/L4 lens frame operating ring 117 are provided each of which has a substantially cylindrical shape having a enter axis along the direction of the optical axis, and is rotatable about the optical axis. The L1/L2 lens frame operating ring 116 is provided at a position for covering the long hole 112. The L3/L4 lens frame operating ring 117 is provided at a position for covering the long hole 113.

The L1/L2 lens frame operating ring 116 and the L3/L4 lens frame operating ring 117 have inner peripheral surfaces formed with helical cam grooves 118 and 119, respectively, having axial directions aligned with the optical axis. The operation transmitting members 114 and 115 are engaged with the cam grooves 118 and 119, respectively.

Although rotation of the L1/L2 lens frame operating ring 116 about the optical axis tends to cause the operation transmitting member 114 engaged with the cam groove 118 to rotate about the optical axis together with the rotation of the L1/L2 lens frame operating ring 116, the operation transmitting member 114 is not allowed to rotate about the optical axis because the operation transmitting member 114 is inserted through the long hole 112, and the operation transmitting member 114 moves only in the direction of the optical axis while changing an engaged position with the cam groove 118. By virtue of such an action of the operation transmitting member 114, the L1/L2 lens frame 107 moves only in the direction of the optical axis (see arrows A and B in FIG. 1) together with the rotation of the L1/L2 lens frame operating ring 116.

Although rotation of the L3/L4 lens frame operating ring 117 about the optical axis tends to cause the operation transmitting member 115 engaged with the cam groove 119 to rotate about the optical axis together with the rotation of the L3/L4 lens frame operating ring 117, the operation transmitting member 115 is not allowed to rotate about the optical axis because the operation transmitting member 115 is inserted through the long hole 113, and the operation transmitting member 115 moves only in the direction of the optical axis while changing an engaged position with the cam groove 119. By virtue of such an action of the operation transmitting member 115, the L3/L4 lens frame 108 moves only in the direction of the optical axis (see arrows C and D in FIG. 1) together with the rotation of the L3/L4 lens frame operating ring 117.

In the first embodiment, an arbitrary lens is realized by the lenses 103 and 104 held by the L1/L2 lens frame 107. Further, another lens is realized by the lenses 105 and 106 held by the L3/L4 lens frame 108 in the first embodiment.

The L1/L2 lens frame 107 includes guide poles 120 as a guide member extending in the direction of the optical axis. The guide poles 120 are rod-like members in which longitudinal directions are aligned with the direction of the optical axis. The guide poles 120 have one ends fixed to the L1/L2 lens frame 107, and other ends supported by a supporting rib 121 provided inside the lens barrel 101. The supporting rib 121 is a plate-like member protruding from an inner peripheral surface of the lens barrel 101 toward the direction of the optical axis.

Although reference numerals are omitted in FIG. 1, the supporting rib 121 is formed with receiving holes penetrating through the supporting rib 121 in the direction of the optical axis. Diameters of the receiving holes are each designed to be equal to or slightly larger than a diameter of each of the guide poles 120. The guide poles 120 move in the direction of the optical axis while sliding relative to the receiving holes, respectively, together with movement of the L1/L2 lens frame 107.

Further, although reference numerals are omitted in FIG. 1, the L3/L4 lens frame 108 is formed with through-holes penetrating therethrough in the direction of the optical axis. Diameters of the through-holes are each designed to be equal to or slightly larger than the diameter of each of the guide poles 120. The through-holes have the guide poles 120 inserted therethrough, respectively, so that the L3/L4 lens frame 108 moves along the guide poles 120. The diaphragm blade mechanism 110 is formed with holes 123 penetrating therethrough in the direction of the optical axis. The guide poles 120 extend up to a side of the L3/L4 lens frame 108 through the holes 123, respectively. In the first embodiment, a slide unit is realized by the through-holes formed through the L3/L4 lens frame 108.

As explained above, the zoom lens apparatus 100 according to the first embodiment is configured to align the optical axes of the L1 lens 103 and L2 lens 104 with the optical axis of the zoom lens apparatus 100 itself by adjusting the position of the L1/L2 lens frame 107, so that the optical axes of the L3 lens 105 and L4 lens 106 held by the L3/L4 lens frame 108 moving along the guide poles 120 can be aligned with the optical axis of the zoom lens apparatus 100.

This enables the zoom lens apparatus 100 to align the optical axes of the lenses 103 to 106, which are movable in the direction of the optical axis, with the optical axis of the zoom lens apparatus 100, thereby ensuring a higher optical performance of the zoom lens apparatus 100. This allows a user of the zoom lens apparatus 100 to obtain images of higher resolution and high-quality.

Further, the zoom lens apparatus 100 according to the first embodiment is capable of aligning the optical axes of the lenses 103 to 106 with the optical axis of the zoom lens apparatus 100 by virtue of such a simple configuration that the guide poles 120 are inserted through the through-holes formed in the L3/L4 lens frame 108, so that the zoom lens apparatus 100 ensuring higher optical performance can be downsized, and an assembling operation thereof can be facilitated.

Furthermore, in a surveillance camera provided with the zoom lens apparatus 100 according to the first embodiment, a focal position for outside light incoming into a housing through the zoom lens apparatus 100 can be precisely adjusted to a photoelectric conversion surface of the CCD provided within the housing. This allows the surveillance camera to attain image-formation on the CCD based on image light at a higher resolution commensurating with advancement of higher pixelation even when the number of the CCD is increased. This allows the user of the surveillance camera provided with the zoom lens apparatus 100 to obtain a clear image.

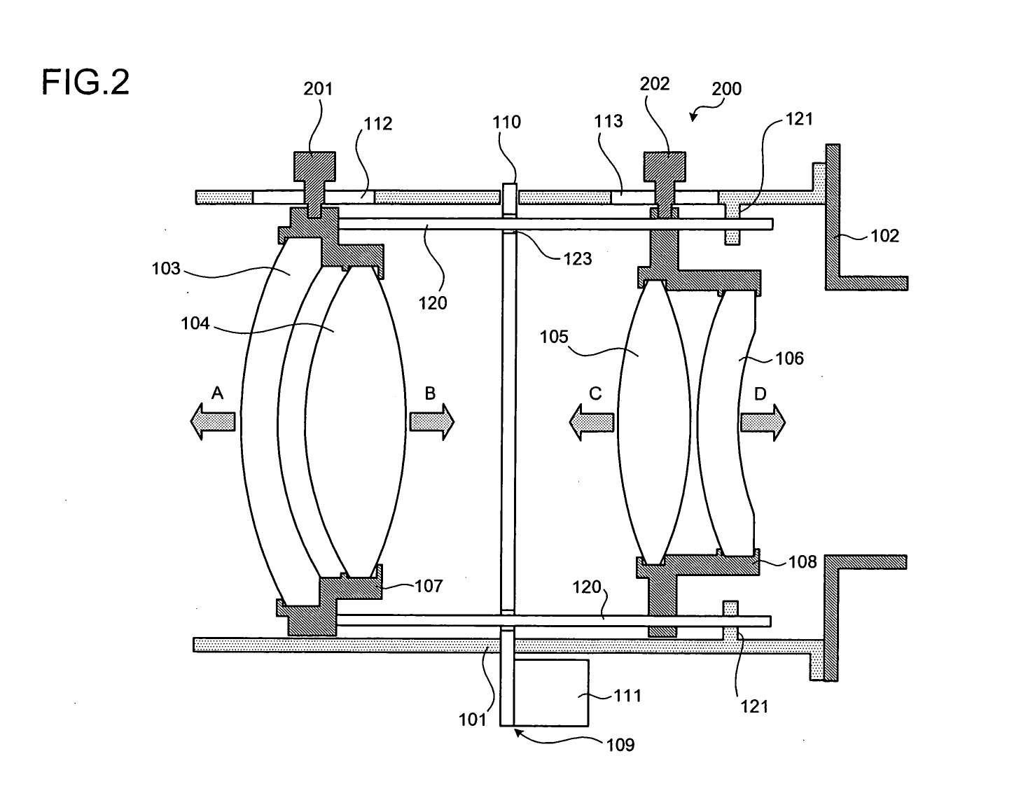

FIG. 2 is a cross-section of a zoom lens apparatus according to a second embodiment of the present invention. In the second embodiment, like reference numerals as used in the first embodiment are used to denote identical elements and explanation thereof is omitted. Identically to the zoom lens apparatus 100, the zoom lens apparatus according to the second embodiment can be used by coupling it to a surveillance camera having a CCD, for example.

As shown in FIG. 2, a zoom lens apparatus 200 according to the second embodiment includes an L1/L2 lens frame operating lever 201 provided instead of the operation transmitting member 114 and the L1/L2 lens frame operating ring 116, and an L3/L4 lens frame operating lever 202 provided instead of the operation transmitting member 115 and the L3/L4 lens frame operating ring 117. The L1/L2 lens frame operating lever 201 is mounted on the L1/L2 lens frame 107 through the long hole 112. The L3/L4 lens frame operating lever 202 is mounted on the L3/L4 lens frame 108 through the long hole 113.

When an external force is applied to the L1/L2 lens frame operating lever 201 by an operation of a user or the like of the zoom lens apparatus 200, the L1/L2 lens frame 107 is moved in the direction of the optical axis correspondingly to the direction of the applied external force. The L1/L2 lens frame operating lever 201 is not allowed to rotate about the optical axis and moves only in the direction of the optical axis, because the L1/L2 lens frame operating lever 201 is inserted through the long hole 112. Such an action of the L1/L2 lens frame operating lever 201 causes the L1/L2 lens frame 107 to move only in the direction of the optical axis (see arrows A and B in FIG. 2) correspondingly to the direction of the applied external force.

When an external force is applied to the L3/L4 lens frame operating lever 202 by an operation of the user or the like of the zoom lens apparatus 200, the L3/L4 lens frame 108 is moved in the direction of the optical axis correspondingly to the direction of the applied external force. The L3/L4 lens frame operating lever 202 is not allowed to rotate about the optical axis and moves only in the direction of the optical axis, because the L3/L4 lens frame operating lever 202 is inserted through the long hole 113. Such an action of the L3/L4 lens frame operating lever 202 causes the L3/L4 lens frame 108 to move only in the direction of the optical axis (see arrows C and D in FIG. 2) correspondingly to the direction of the applied external force.

As explained above, the zoom lens apparatus 200 according to the second embodiment is capable of aligning the optical axes of the lenses 103 to 106 with the optical axis of the zoom lens apparatus 200 by virtue of a simple configuration that the user or the like of the zoom lens apparatus 200 directly operates the L1/L2 lens frame operating lever 201 and the L3/L4 lens frame operating lever 202, so that the zoom lens apparatus 200 ensuring higher optical performance can be downsized, and an assembling operation thereof can be facilitated.

This allows the zoom lens apparatus 200 to ensure a higher optical performance thereof by facilitating alignment of the lenses 103 to 106 movable in the direction of the optical axis with the optical axis of the zoom lens apparatus 200. Thus, the user of the zoom lens apparatus 200 is allowed to obtain images of higher resolution and high-quality.

Further, in a surveillance camera provided with the zoom lens apparatus 200 according to the second embodiment, a focal position for outside light incoming into a housing through the zoom lens apparatus 200 can be precisely adjusted to a photoelectric conversion surface of the CCD provided within the housing. This allows the surveillance camera to attain image-formation on the CCD based on image light at a higher resolution commensurating with advancement of higher pixelation even when the number of the CCD is increased. This allows the user of the surveillance camera provided with the zoom lens apparatus 200 to obtain a sharp image.

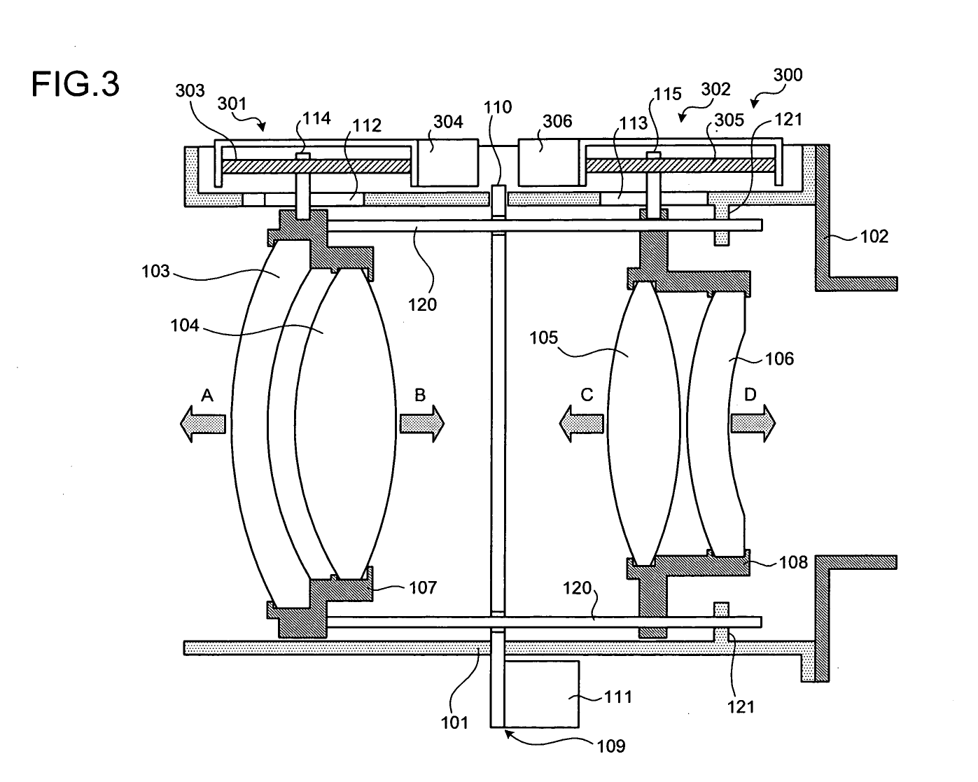

FIG. 3 is a cross-sectional view of a zoom lens apparatus according to a third embodiment. Next, the configuration of the zoom lens apparatus according to the third embodiment will be explained based on FIG. 3. In the third embodiment, like reference numerals as used in the first and the second embodiments are used to denote identical elements and explanation thereof is omitted. Identically to the zoom lens apparatus 100 and 200, the zoom lens apparatus according to the third embodiment can be used by coupling it to a surveillance camera having a CCD, for example.

As shown in FIG. 3, a zoom lens apparatus 300 according to the third embodiment includes an L1/L2 lens frame driving motor unit 301 provided instead of the L1/L2 lens frame operating ring 116, and an L3/L4 lens frame driving motor unit 302 provided instead of the L3/L4 lens frame operating ring 117.

The L1/L2 lens frame driving motor unit 301 includes a shaft 303 provided at an outer peripheral side of the lens barrel 101 and having an axial direction aligned with the direction of the optical axis, and a motor 304 that generates a driving force for rotating the shaft 303 about an axis of the shaft 303 itself. Although reference numeral is omitted in FIG. 3, the shaft 303 has an outer periphery formed with a helicoid groove. Further, although reference numeral is omitted in FIG. 3, the helicoid groove formed on the outer periphery of the shaft 303 is meshed with a helicoid groove formed on the operation transmitting member 114 mounted on the L1/L2 lens frame 107.

The L3/L4 lens frame driving motor unit 302 includes a shaft 305 provided at an outer peripheral side of the lens barrel 101 and having an axial direction aligned with the direction of the optical axis, and a motor 306 that generates a driving force for rotating the shaft 305 about an axis of the shaft 305 itself. Although reference numeral is omitted in FIG. 3, the shaft 305 has an outer periphery formed with a helicoid groove, similarly to the shaft 303. Further, although reference numeral is omitted in FIG. 3, the helicoid groove formed at the outer periphery of the shaft 305 is meshed with a helicoid groove formed at the operation transmitting member 115 mounted on the L3/L4 lens frame 108.

Although rotation of the shaft 303 having the driving force transmitted from the motor 304 about the axis of the shaft 303 itself tends to cause the operation transmitting member 114 meshed with the helicoid groove formed on the outer periphery of the shaft 303 to rotate about the optical axis together with the rotation of the shaft 303, the operation transmitting member 114 is not allowed to rotate about the optical axis because the operation transmitting member 114 is inserted through the long hole 112, and the operation transmitting member 114 moves only in the direction of the optical axis while changing a meshed position with the shaft 303. By virtue of such an action of the operation transmitting member 114, the L1/L2 lens frame 107 moves only in the direction of the optical axis (see arrows A and B in FIG. 3) together with the rotation of the shaft 303.

Further, although rotation of the shaft 305 having the driving force transmitted from the motor 306 about the axis of the shaft 305 itself tends to cause the operation transmitting member 115 meshed with the helicoid groove formed on the outer periphery of the shaft 305 to rotate about the optical axis together with the rotation of the shaft 305, the operation transmitting member 115 is not allowed to rotate about the optical axis because the operation transmitting member 115 is inserted through the long hole 112, and the operation transmitting member 115 moves only in the direction of the optical axis while changing a meshed position with the shaft 305. By virtue of such an action of the operation transmitting member 115, the L1/L2 lens frame 108 moves only in the direction of the optical axis (see arrows C and D in FIG. 3) together with the rotation of the shaft 305.

As explained above, the zoom lens apparatus 300 according to the third embodiment utilizes driving forces of the motor 304 and the motor 306 to move the L1/L2 lens frame 107 and the L3/L4 lens frame 108 in the direction of the optical axis, thereby enabling fine adjustment of moving distances of the L1/L2 lens frame 107 and L3/L4 lens frame 108 with a higher precision.

This allows the zoom lens apparatus 300 to ensure a higher optical performance thereof by facilitating alignment of the lenses 103 to 106 movable in the direction of the optical axis with the optical axis of the zoom lens apparatus 300. Thus, the user of the zoom lens apparatus 300 is allowed to obtain images of higher resolution and high-quality.

Further, in a surveillance camera provided with the zoom lens apparatus 300, a focal position for outside light incoming into a housing through the zoom lens apparatus 300 can be precisely adjusted to a photoelectric conversion surface of a CCD provided within the housing. This allows the surveillance camera to attain image-formation on the CCD based on image light at a higher resolution commensurating with advancement of higher pixelation even when the number of the CCD is increased. This allows the user of the surveillance camera provided with the zoom lens apparatus 300 to obtain a sharp image.

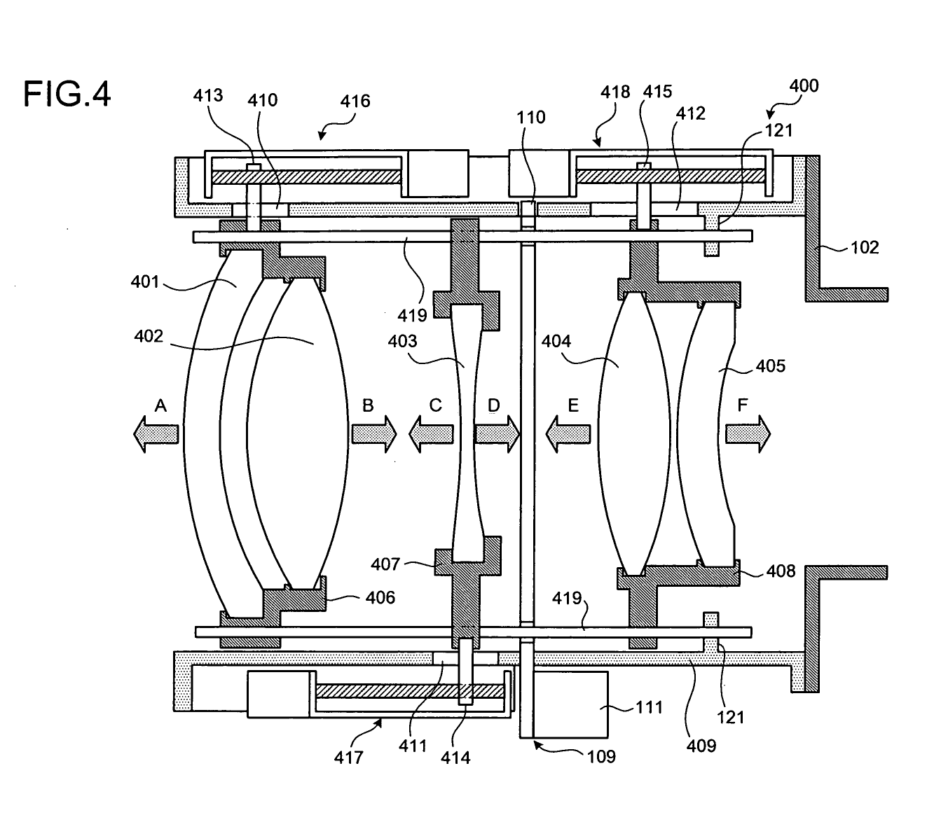

FIG. 4 is a cross-section of a zoom lens apparatus according to a fourth embodiment of the present invention. In the fourth embodiment, like reference numerals as used in the first, the second, and the third embodiments are used to denote identical elements and explanation thereof is omitted. Identically to the zoom lens apparatus 100, 200, and 300, the zoom lens apparatus according to the fourth embodiment can be used by coupling it to a surveillance camera having a CCD, for example.

As shown in FIG. 4, a zoom lens apparatus 400 includes a plurality of lenses 401 to 405. Among the lenses 401 to 405, the lens designated by reference numeral 401 in FIG. 4 (hereinafter, “L1 lens”) and the lens designated by reference numeral 402 in FIG. 4 (hereinafter, “L2 lens”) are held by an L1/L2 lens frame 406. Among the lenses 401 to 405, the lens designated by reference numeral 403 in FIG. 4 (hereinafter, “L3 lens”) is held by an L3 lens frame 407.

Further, among the lenses 401 to 405, the lens designated by reference numeral 404 in FIG. 4 (hereinafter, “L4 lens”) and the lens designated by reference numeral 405 in FIG. 4 (hereinafter, “L5 lens”) are held by an L4/L5 lens frame 408. The L1/L2 lens frame 406, L3 lens frame 407, and L4/L5 lens frame 408 mount thereon operation transmitting members 413, 414, and 415 inserted through long holes 410 to 412 formed through a lens barrel 409, respectively, so that the lens frames are provided to be movable only in the direction of the optical axis.

Provided at positions at an outer peripheral side of the lens barrel 409 and opposite to the long holes 410 to 412, are an L1/L2 lens frame driving motor unit 416, an L3 lens frame driving motor unit 417, and an L4/L5 lens frame driving motor unit 418, respectively. Although reference numerals are omitted in FIG. 4, the lens frame driving motor units 416 to 418 include shafts having axial directions aligned with the direction of the optical axis, and motors that generate driving forces for rotating the shafts about axes of the shafts themselves, respectively.

Outer peripheries of the shafts included in the lens frame driving motor units 416 to 418 are formed with helicoid grooves, respectively, and the helicoid grooves are meshed with helicoid grooves formed on the operation transmitting members 413 to 415, respectively. This causes the L1/L2 lens frame 406, L3 lens frame 407, and L4/L5 lens frame 408 to move only in the direction of the optical axis (see arrows A to F in FIG. 4).

In the fourth embodiment, an arbitrary lens is realized by the L3 lens 403 held by the L3 lens frame 407. Further, another lens is realized by the lenses 401, 402, 403, 404, and 405 held by the L1/L2 lens frame 406 and L4/L5 lens frame 408 in the fourth embodiment.

The L3 lens frame 407 includes guide poles 419 as a guide member extending in the direction of the optical axis. The guide poles 419 are rod-like members that have longitudinal directions aligned with the direction of the optical axis, and that have central portions in the longitudinal direction fixed to the L3 lens frame 407. Ends of the guide poles 419 located at the L4/L5 lens frame 408 side are supported by the supporting rib 121 provided inside the lens barrel 409.

Although reference numerals are omitted in FIG. 4, the L4/L5 lens frame 408 is formed with through-holes penetrating through the L4/L5 lens frame 408 itself and having the guide poles 419 inserted through the through-holes, respectively. Diameters of the through-holes formed in the L4/L5 lens frame 408 are each designed to be equal to or slightly larger than the diameter of each of the guide pole 419. The L4/L5 lens frame 408 is moved in the direction of the optical axis along the guide poles 419, together with rotation of the shaft by a driving force generated by the motor in the L4/L5 lens frame driving motor unit 418.

Further, although reference numerals are omitted in FIG. 4, ends of the guide poles 419 at the L1/L2 lens frame 406 side are inserted through through-holes that are formed in the L1/L2 lens frame 406 and that penetrate through the L1/L2 lens frame 406 in the direction of the optical axis, respectively. Diameters of the through-holes formed in the L1/L2 lens frame 406 are each designed to be equal to or slightly larger than the diameter of each of the guide poles 419. The L1/L2 lens frame 406 is moved in the direction of the optical axis along the guide poles 419, together with rotation of the shaft by a driving force generated by the motor in the L1/L2 lens frame driving motor unit 416.

The dimensions of the guide poles 419 in the direction of the optical axis are each designed to have such a length that the guide poles 419 are prevented from being disengaged from the L1/L2 lens frame 406, the supporting rib 121, or the L4/L5 lens frame 408, even when the L1/L2 lens frame 406 and the L3 lens frame 407 are most separated from each other, the L3 lens frame 407 and the L4/L5 lens frame 408 are most separated from each other, and the L1/L2 lens frame 406 and the L4/L5 lens frame 408 are most separated from each other. In the fourth embodiment, slide units are realized by the through-holes formed through the L1/L2 lens frame 406 and the L4/L5 lens frame 408.

As explained above, the zoom lens apparatus 400 according to the fourth embodiment is configured to adjust the position of the L3 lens frame 407 to align the optical axis of the L3 lens 403 with the optical axis of the zoom lens apparatus 400, so that the optical axes of the L1 lens 401 and L2 lens 402 held by the L1/L2 lens frame 406 moving along the guide poles 419 and optical axes of the L4 lens 404 and L5 lens 405 held by the L4/L5 lens frame 408 moving along the guide poles 419 can be aligned with the optical axis of the zoom lens apparatus 400.

Further, the zoom lens apparatus 400 according to the fourth embodiment is capable of aligning the optical axes of the lenses 401, 402, 404, and 405 held by the lens frames 406 and 408 with the optical axis of the zoom lens apparatus 400 itself by simply adjusting the position of the L3 lens frame 407 having the guide poles 419 fixed thereto, even when one-to-one correspondence is not established between the L1/L2 lens frame 406 and L4/L5 lens frame 408 that utilizes, as references of positions upon moving, the L3 lens frame 407 having the guide poles 419 fixed thereto and the guide poles 419 themselves fixed to the L3 lens frame 407.

Furthermore, in a surveillance camera provided with the zoom lens apparatus 400 according to the fourth embodiment, a focal position for outside light incoming into a housing through the zoom lens apparatus 400 can be precisely adjusted to a photoelectric conversion surface of a CCD provided within the housing. This allows the surveillance camera to attain image-formation on the CCD based on image light at a higher resolution commensurating with advancement of higher pixelation even when the number of the CCD is increased. This allows the user of the surveillance camera provided with the zoom lens apparatus 400 to obtain a sharp image.

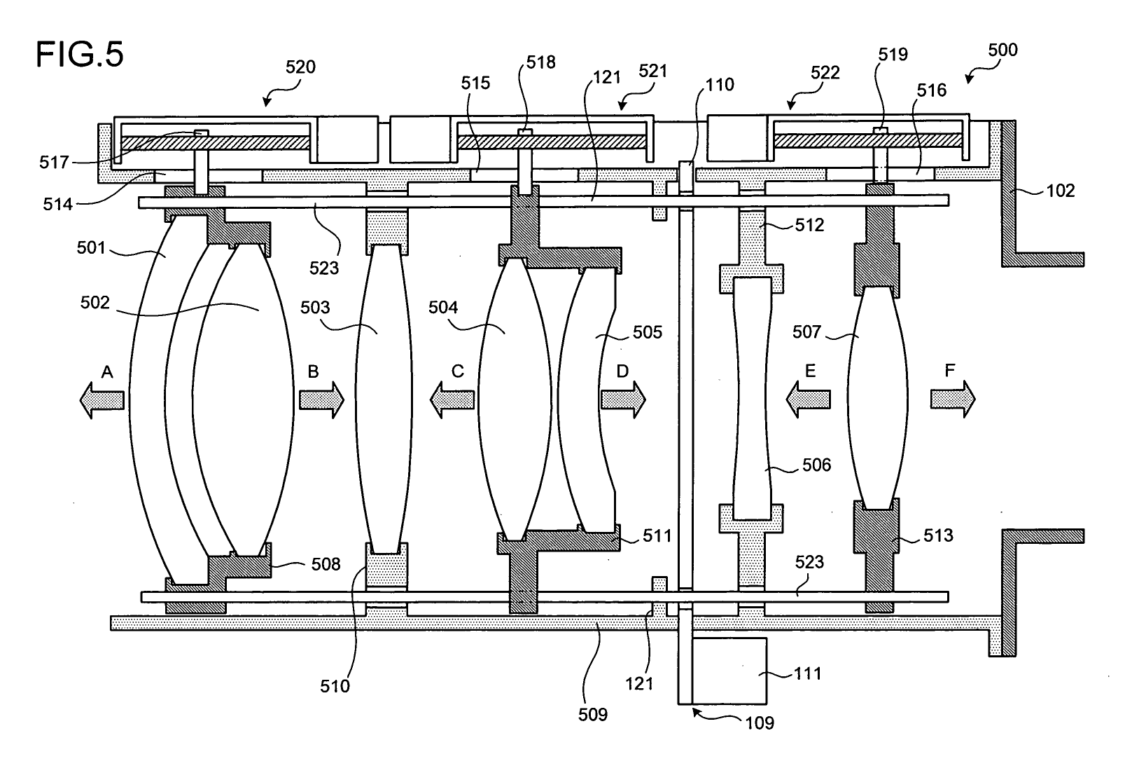

FIG. 5 is a cross-section of a zoom lens apparatus according to a fifth embodiment of the present invention. In the fifth embodiment, like reference numerals as used in the first, the second, the third, and the fourth embodiments are used to denote identical elements and explanation thereof is omitted. Identically to the zoom lens apparatus 100, 200, 300, and 400, the zoom lens apparatus according to the fifth embodiment can be used by coupling it to a surveillance camera having a CCD, for example.

As shown in FIG. 5, a zoom lens apparatus 500 according to the fifth embodiment includes a plurality of lenses 501 to 507. Among the lenses 501 to 507, the lens designated by reference numeral 501 in FIG. 5 (hereinafter, “L1 lens”) and the lens designated by reference numeral 502 in FIG. 5 (hereinafter, “L2 lens”) are held by an L1/L2 lens frame 508. Among the lenses 501 to 507, the lens designated by reference numeral 503 in FIG. 5 (hereinafter, “L3 lens”) is supported by an L3 lens supporting member 510 provided inside a lens barrel 509.

Further, among the lenses 501 to 507, the lens designated by reference numeral 504 in FIG. 5 (hereinafter, “L4 lens”) and the lens designated by reference numeral 505 in FIG. 5 (hereinafter, “L5 lens”) are held by an L4/L5 lens frame 511. Among the lenses 501 to 507, the lens designated by reference numeral 506 in FIG. 5 (hereinafter, “L6 lens”) is supported by an L6 lens supporting member 512 provided inside the lens barrel 509.

Among the lenses 501 to 507, the lens designated by reference numeral 507 in FIG. 5 (hereinafter, “L7 lens”) is held by an L7 lens frame 513. The L1/L2 lens frame 508, L4/L5 lens frame 511, and the L7 lens frame 513 mount thereon operation transmitting members 517 to 519 inserted through long holes 514 to 516 formed through the lens barrel 509, respectively, so that the lens frames are provided to be movable only in the direction of the optical axis.

Provided at positions at an outer periphery side of the lens barrel 509 and opposite to the long holes 514 to 516, are an L1/L2 lens frame driving motor unit 520, an L4/L5 lens frame driving motor unit 521, and an L7 lens frame driving motor unit 522, respectively. Although reference numerals are omitted in FIG. 5, the lens frame driving motor units 520 to 522 include shafts having axial directions aligned with the direction of the optical axis, and motors that generate driving forces for rotating the shafts about axes of the shafts themselves, respectively.

Outer peripheries of the shafts included in the lens frame driving motor units 520 to 522 are formed with helicoid grooves, respectively, and the helicoid grooves are meshed with helicoid grooves formed on the operation transmitting members 517 to 519, respectively. This causes the L1/L2 lens frame 508, L4/L5 lens frame 511 and the L7 lens frame 513 to move only in the direction of the optical axis (see arrows A to F in FIG. 5).

In the fifth embodiment, an arbitrary lens is realized by the lenses 504 and 505 held by the L4/L5 lens frame 511. Further, another lens is realized by the lenses 501, 502, and 507 held by the L1/L2 lens frame 508 and the L7 lens frame 513 in the fifth embodiment. Furthermore, a fixed lens is realized in the fifth embodiment, by the lenses 503 and 506 held by the L3 lens supporting member 510 and the L6 lens supporting member 512, respectively.

The L4/L5 lens frame 511 includes guide poles 523 as a guide member extending in the direction of the optical axis. The guide poles 523 are rod-like members that have longitudinal directions aligned with the direction of the optical axis, and that have central portions in the longitudinal direction fixed to the L4/L5 lens frame 511. Although reference numerals are omitted in FIG. 5, the L1/L2 lens frame 508 and the L7 lens frame 513 are formed with through-holes penetrating through the L1/L2 lens frame 508 and the L7 lens frame 513. In the fifth embodiment, slide units are realized by the through-holes formed through the L1/L2 lens frame 508 and the L7 lens frame 513, respectively.

Both ends of the guide poles 523 extended from the intermediate L4/L5 lens frame 511 are inserted through the through-holes formed in the L1/L2 lens frame 508 and the L7 lens frame 513, and protruded out of the L1/L2 lens frame 508 and the L7 lens frame 513 oppositely from the L4/L5 lens frame 511, respectively.

Although reference numerals are omitted in FIG. 5, the L3 lens supporting member 510 and the L6 lens supporting member 512 are formed with through-holes penetrating through the L3 lens supporting member 510 and the L6 lens supporting member 512 themselves in the direction of the optical axis, respectively. The guide poles 523 are extended from the fixed positions at the L4/L5 lens frame 511, through the through-holes formed through the L3 lens supporting member 510 and the L6 lens supporting member 512, and up to the L1/L2 lens frame 508 and the L7 lens frame 513, respectively.

Diameters of the through-holes formed through the L3 lens supporting member 510 and the L6 lens supporting member 512 are each designed to be equal to or slightly larger than the diameter of each of the guide poles 523. The guide poles 523 move in the direction of the optical axis along the through-holes formed through the L3 lens supporting member 510 and the L6 lens supporting member 512, together with rotation of the shaft by a driving force generated by the motor in the L4/L5 lens frame driving motor unit 521.

The supporting rib 121 is provided inside the lens barrel 509 and near the diaphragm blade mechanism 110. The guide poles 523 are inserted through the holes 123 formed through the supporting rib 121 so that the guide poles 523 are supported by the supporting rib 121 in a state slidable through the supporting rib 121.

As explained above, the zoom lens apparatus 500 according to the fifth embodiment is capable of aligning the optical axes of the lenses 501, 502, 504, and 505 held by the L1/L2 lens frame 508 and the L4/L5 lens frame 511 with the optical axis of the zoom lens apparatus 500 even when the L3 lens 503 supported by the positionally fixed L3 lens supporting member 510 is located between the L1/L2 lens frame 508 and the L4/L5 lens frame 511, thereby enabling higher optical performance to be ensured in the zoom lens apparatus 500 including the lenses 501, 502, 504, and 505 movable in the direction of the optical axis, irrespectively of an arrangement order of the lenses 501 to 507 in the zoom lens apparatus 500.

Further, the zoom lens apparatus 500 according to the fifth embodiment is capable of aligning the optical axes of the lenses 504, 505, and 507 held by the L4/L5 lens frame 511 and the L7 lens frame 513 with the optical axis of the zoom lens apparatus 500 even when the L6 lens 506 supported by the positionally fixed L6 lens supporting member 512 is located between the L4/L5 lens frame 511 and the L7 lens frame 513, thereby enabling higher optical performance to be ensured in the zoom lens apparatus 500 including the lenses 504, 505, and 507 movable in the direction of the optical axis, irrespectively of an arrangement order of the lenses 501 to 507 in the zoom lens apparatus 500.

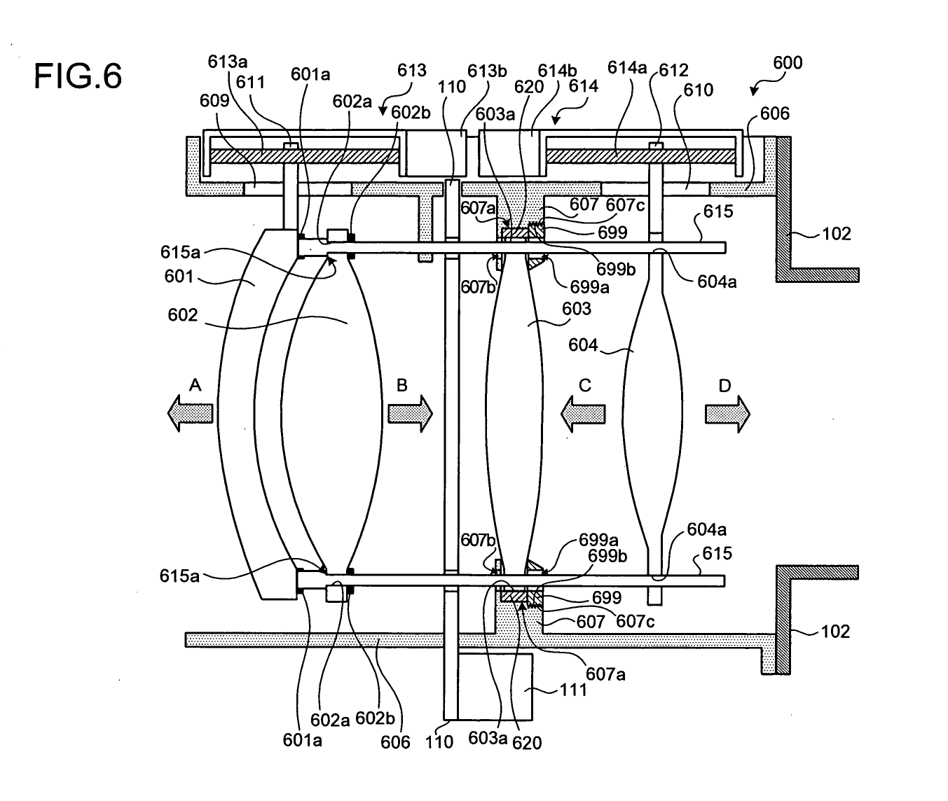

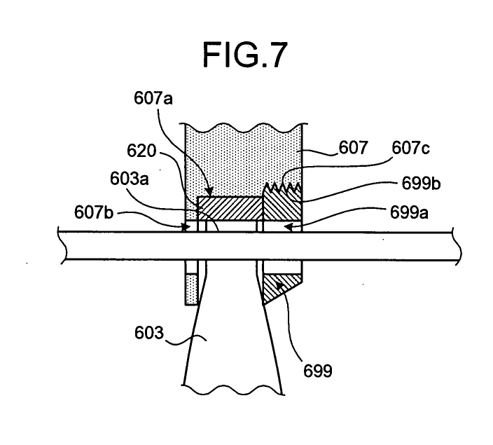

FIG. 6 is a cross sectional view of a zoom lens apparatus according to the sixth embodiment of the present invention. FIG. 7 is an enlarged view of a portion of the zoom lens apparatus. In the sixth embodiment, like reference numerals as used in the first, the second, the third, the fourth, and the fifth embodiments are used to denote identical elements and explanation thereof is omitted. Identically to the zoom lens apparatus 100, 200, 300, 400, and 500, the zoom lens apparatus according to the sixth embodiment can be used by coupling it to a surveillance camera having a CCD, for example.

As shown in FIG. 6, a zoom lens apparatus 600 according to the sixth embodiment includes a plurality of lenses 601 to 604. The lenses 601 to 604 are coupled to a guide pole 615, which serves as a guide member. Among the lenses 601 to 604, the lens 601 (hereinafter, “L1 lens”) and the lens 602 (hereinafter, “L2 lens”) have fixed positions relative to the guide pole 615. According to the sixth embodiment, an arbitrary lens is realized by the L1 lens 601 and the L2 lens 602.

The guide pole 615 has a rod-like shape extending along the direction of the optical axis. An end of the guide pole 615 is inserted through an opening (not shown in figure) disposed in the L1 lens 601. With an end of the guide pole 615 inserted in the opening of the L1 lens 601, a retaining ring 601a is fit into the opening to prevent detachment of the guide pole 615 from the L1 lens 601.

The guide pole 615 has an adjustor 615a that changes the effective outer diameter of the guide pole 615. The adjustor 615a is disposed between the L1 lens 601 and the L2 lens 602. The effective outer diameter of the guide pole 615 at the adjustor 615a is larger on the L1 lens 601 side than on the L2 lens 602 side.

The guide pole 615 is inserted through a through-hole 602a that passes through the L2 lens 602 along the direction of the optical axis. The diameter of the through-hole 602a is approximately the same as the relatively smaller effective outer diameter of the guide pole 615 (i.e., the smaller outer diameter of the adjustor 615a) and smaller than the relatively larger effective outer diameter of the guide pole 615 (i.e., the larger outer diameter of the adjustor 615a). As a result, the L2 lens 602 is prevented from moving, along the guide pole 615, closer toward the L1 lens 601 than the adjustor 615a.

A retaining ring 602b is disposed in the through-hole 602a. With the guide pole 615 inserted through the through-hole 602a, the retaining ring 602b is fit into the through-hole 602a from the side opposite of the L1 lens 601, thereby preventing the guide pole 615 from dislodging from the through-hole 602a. The position of the L2 lens 602 with respect to the guide pole 615, i.e., the position of the L2 lens 602 in the direction of the optical axis, can be fixed at the adjustor 615a by the retaining ring 602b.

Among the lenses 601 to 604, the lens 603 (hereinafter, “L3 lens”) is fixed to a lens barrel 606. The L3 lens 603 is supported by a lens barrel (lens supporting member) 607. Within the interior of the lens barrel 606, the lens barrel (lens supporting member) 607 extends toward the center of the lens barrel 606. A slit 607a is disposed in the lens barrel (lens supporting member) 607. According to the sixth embodiment, a fixed lens is realized by the L3 lens 603 and a fixed lens supporting member is realized by the lens barrel (lens supporting member) 607.

In the lens barrel (lens supporting member) 607, the L3 lens 603 is positioned therebetween and a ring member 699 is provided on the side opposite of the L2 lens 602. The exterior surface of the ring member 699 is provided with a helicoid groove 699b that meshes with a helicoid groove 607c provided on a surface of the lens barrel (lens supporting member) 607, the surface facing towards the optical axis. The ring member 699 is fixed to the lens barrel (lens supporting member) 607 by a meshing of the helicoid groove 699b and the helicoid groove 607c, thereby also forming the slit 607a. An end of the L3 lens 603 is inserted into the slit 607a to be supported by the slit 607a.

During assembly of the zoom lens apparatus 600, without the ring member 699 positioned in the lens barrel (lens supporting member) 607, the L3 lens 603 is disposed in the lens barrel 606. After the L3 lens 603 is disposed in the lens barrel 606, the ring member 699 is meshed with the lens barrel (lens supporting member) 607, thereby fixing the position of the L3 lens 603 along the direction of the optical axis of the zoom lens apparatus to prevent detachment of the L3 lens 603.

As shown in FIG. 7, an opening 607b is provided in the lens barrel (lens supporting member) 607 and an opening 699a for each guide pole 615 is provided in the ring member 699. The openings 607b, 699a pass through a position of the slit 607a and through the lens barrel (lens supporting member) 607 and the ring member 699, respectively, along the direction of the optical axis of the zoom lens apparatus 600.

The diameters of the openings 607b, 699a are larger than the outer diameter of the guide pole 615. The L3 lens 603 is disposed with a through-hole 603a that passes through the L3 lens 603 in the direction of the optical axis. The through-hole 603a has a diameter that is approximately the same as the outer diameter of the guide pole 615 or slightly larger. The guide pole 615 is inserted through the openings 607b, 699a and the through-hole 603a.

An elastic member 620 is disposed in the slit 607a. The elastic member 620 has a ring-shape and is positioned farther away from the optical axis than the edge of the L3 lens 603. The elastic member 620 having an elastic quality is deformed between the slit 607a and the L3 lens 603, and by the resulting resilient force, forces directed toward the center of the lens barrel 606 from opposing directions fix the position of the L3 lens 603 in a plane that crosses the optical axis. The guide pole 615, which is inserted into the L3 lens 603, fixes the L3 lens 603 in a position that aligns the optical axis of the L3 lens 603 with the optical axes of the L1 lens 601 and the L2 lens 602.

Among the lenses 601 to 604, the lens 604 (hereinafter, “L4 lens”) is disposed with a through-hole 604a that passes through the L4 lens 604 along the direction of the optical axis. The diameter of the through-hole 604a is approximately the same as the outer diameter of the guide pole 615. The L4 lens 604 can slide along the guide pole 615. According to the sixth embodiment, a slide unit is realized by the L4 lens 604 and the through-hole 604a.

Long openings 609, 610 are disposed in the lens barrel 606 and pass through the lens barrel in a direction that crosses the optical axis. Assuming a longitudinal aspect of the long openings 609, 610 to be a substantially greatest dimension of the long openings 609, 610, the longitudinal aspect of the long openings 609, 610 is parallel to the optical axis. Operation transmitting members 611, 612 are inserted respectively in each of the long openings 609, 610 such that the operation transmitting members 611, 612 are slidable along the longitudinal aspect of the long openings 609, 610. The operation transmitting member 611 is attached to the L1 lens 601 and the operation transmitting member 612 is attached to the L4 lens 604.

The operation transmitting members 611, 612 are moveable along the longitudinal aspect of the long openings 609, 610 within the long openings 609, 610. In other words, the operation transmitting members 611, 612 are moveable in the direction of the optical axis. As the operation transmitting members 611, 612 are respectively disposed on the L1 lens 601 and the L4 lens 604, the L1 lens 601 and the L4 lens 604 are each moveable in the direction of the optical axis by the movement of the operation transmitting members 611, 612 along the long openings 609, 610.

Provided at positions at an outer peripheral side of the lens barrel 606 opposing the long holes 609, 610, are an L1/L2 lens driving motor unit 613 and an L4 lens driving motor unit 614, respectively. The lens driving motor units 613, 614 include lead screws 613a, 614a having axial directions aligned with the direction of the optical axis, and motors that generate driving forces for rotating the lead screws 613a, 614a about axes thereof, respectively.

The outer surface of the lead screws 613a, 614a are provided with a helicoid groove, respectively, and the helicoid groove is meshed with a helicoid groove formed on the operation transmitting members 611, 612, respectively, thereby moving the L1 lens 601, the L2 lens 602, and the L4 lens 604 only along the direction of the optical axis (see arrows A to D in FIG. 6).

With the L1/L2 lens driving motor unit 613 in operation and the L4 lens driving motor unit 614 stopped, the L1 lens 601 and the L2 lens 602 move with respect to the L3 lens 603. With this movement, the guide pole 615 slides within the through-holes 603a, 604a, thereby changing the position of the L3 lens 603 and the L4 lens 604 with respect to the guide pole 615.

With the L1/L2 lens driving motor unit 613 stopped and the L4 lens driving motor unit 614 in operation, the L4 lens 604 moves with respect to the L3 lens 603. With this movement, the position of the L4 lens 604 with respect to the guide pole 615 is changed and the L4 lens 604 is moved along the direction of the optical axis.

With both the L1/L2 lens driving motor unit 613 and the L4 lens driving motor unit 614 in operation, the L1 lens 601, the L2 lens 602, and the L4 lens 604 each move, with respect to the L3 lens 603, in a direction corresponding to the rotational direction of the each of the lens driving motor units 613, 614. With this movement, the position of the guide pole 615, with respect to the L3 lens 603 and the L4 lens 604, is appropriately moved.

According to the sixth embodiment, an arbitrary lens is realized by the L1 lens 601 and L2 lens 602 disposed with the guide pole 615, and without providing a lens supporting member to support the arbitrary lens, the operation transmitting member 611 and the guide pole 615 are directly attached to the L1 lens 601.

Also, according to the sixth embodiment, the other lens is realized by the L4 lens 604 that is disposed with the through-hole 604a, and no lens supporting member is provided to support this other lens.

In the sixth embodiment, an example is described in which the guide pole 615 is provided as a guide member on the L1 lens 601 and L2 lens 602 that form the arbitrary lens. However, without limitation thereto, the guide pole 615 may be provided on an L1/L2 lens frame that is a support for the arbitrary lens as described in the first to fifth embodiments.

As described above, the guide pole 615 is directly fixed to the L1 lens 601 and the through-holes 602a, 603a, and 604a are provided directly in the L2 lens 602, the L3 lens 603, and the L4 lens 604, respectively. However, despite each optical member being directly subjected to such processing, the optical performance of the zoom lens apparatus 600 is not affected as the processing is implemented outside of the effective optical range.

As described above, according to the zoom lens apparatus 600 of the sixth embodiment, the guide pole 615 is directly fixed to the L1 lens 601; and the L2 lens 602, the L3 lens 603, and the L4 lens 604 are disposed with the through-holes 602a, 603a, and 604a, wherein such direct modification of the optical elements is performed outside the effective optical range of each optical element.

As a result, negative effects on the optical performance of the zoom lens apparatus 600 can be circumvented, which further results in high optical performance without regard for a left/right arrangement sequence of the L1 lens 601, the L2 lens 602, the L3 lens 603, and the L4 lens 604 because the L1 lens 601, the L2 lens 602, and the L4 lens 604 can be disposed in a moveable manner along the optical axis.

According to the zoom lens apparatus 600 of the sixth embodiment, even when there is an optical element in a fixed position between the arbitrary lens formed by the L1 lens 601 and the L2 lens 602 and the other lens formed by the L4 lens 604, the optical axis of each of the L1 lens 601 to the L4 lens 604 can be aligned in the zoom lens apparatus 600 because the guide pole 615 is slidable even with respect to the L3 lens 603, the position of which is fixed.

As a result, high optical performance can be secured with the zoom lens apparatus 600 as the optical axes of the L1 lens 601 to the L4 lens 604, which are moveable along the direction of the optical axis, are aligned with the optical axis of the zoom lens apparatus 600 to thereby enable a user of the zoom lens apparatus 600 to obtain high resolution and high quality images.

According to the embodiments described above, higher optical performance is ensured.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2006-286449 filed in Japan on Oct. 20, 2006.

What is claimed is:

1. An optical device having a plurality of lenses that are movable in a direction of an optical axis, the optical device comprising:
a guide member that extends in the direction of the optical axis and that is integrally moved with one of the lenses; and
a slide unit that is slidable along the guide member, and that is integrally moved with another one of the lenses.

2. The optical device according to claim 1, wherein the slide unit includes a through hole that penetrates through the other one of the lenses in the direction of the optical axis, the through hole through which the guide unit is put.

3. The optical device according to claim 1, wherein the slide unit includes a through hole that penetrates through a supporting member that supports the other one of the lenses, the through hole through which the guide unit is put.

4. The optical device according to claim 1, wherein the guide member is a rod-like member that is mounted on the one of the lenses.

5. The optical device according to claim 1, wherein the guide member is a rod-like member that is mounted on a supporting member supporting the one of the lenses.

6. The optical device according to claim 1, further comprising a fixed lens that is fixed at a position on the optical axis between the one of the lenses and the other one of the lenses, wherein
the guide member passes through the fixed lens to slide along the slide unit.

7. The optical device according to claim 1, further comprising a fixed lens that is fixed at a position on the optical axis between the one of the lenses and the other one of the lenses, wherein
the guide member passes through the supporting member supporting the fixed lens to pass through the slide unit.

8. An imaging apparatus comprising:
the optical device according to claim 1, and
an imaging mechanism including a photoelectric conversion element that converts incident light entering through the optical device, into an electrical signal.
